(19) United States
(12) Patent Application Publication
(10) Pub. No.: US 2012/0311963 A1
(43) Pub. Date: Dec. 13, 2012

(54) CAP FASTENING APPARATUS

(75) Inventors: Tsutomu Fukuda, Kawasaki-shi (JP); Yasuhiro Tanaka, Kawasaki-shi (JP)

(73) Assignee: KAO CORPORATION, TOKYO (JP)

(21) Appl. No.: 13/578,958

(22) PCT Filed: Feb. 17, 2011
(86) PCT No.: PCT/JP2011/053380

§ 371 Date: Aug. 14, 2012

(30) Foreign Application Priority Data
Feb. 22, 2010 (JP) 2010-036570

(51) Int. Cl. B67B 3/20

(52) U.S. Cl. 53/317

(57) ABSTRACT

In a cap fastening apparatus 10 in which a rotation of a motor 20 is transmitted to a chuck 50 while being decelerated by a speed reducer 40, and a cap 1 gripped by the chuck 50 is threadably attached to a bottle 2, a torque limiter apparatus 30 is interposed between the motor 20 and the speed reducer 40, the torque limiter apparatus 30 disconnecting a transmission of a rotation from the motor 20 to the chuck 50 at a time when a rotational resistance of the chuck 50 becomes larger than a set torque.

### TECHNICAL FIELD

The present invention relates to a cap fastening apparatus.

### BACKGROUND ART

As a cap fastening apparatus, as described in Patent Document 1, there is a structure in which a rotation of a motor is decelerated by a speed reducer so as to be transmitted to a chuck, and a cap gripped by the chuck is threadably attached to a bottle. The cap fastening apparatus described in Patent Document 1 is structured such that a torque limiter which is an apparatus for disconnecting a transmission of the rotation from the motor to the chuck at a time when a rotational resistance of the chuck becomes larger than a set torque is interposed between the speed reducer and the chuck.

### PRIOR ART DOCUMENT

### Patent Document

Patent Document 1: Japanese Patent Application Laid-Open (JP-A) No. 2004-123109

### SUMMARY OF THE INVENTION

### Problem to be Solved by the Invention

The cap fastening apparatus described in Patent Document 1 has the following problems:

(1) The rotation of the motor which is decelerated by the speed reducer is limited by the torque limiter apparatus so as to be transmitted to the chuck. The set torque which is necessary for fastening the cap by the chuck is directly limited by the torque limiter apparatus, and a capacity which is necessary for the torque limiter apparatus becomes immediately larger in correspondence to a magnitude of the set torque.

In accordance with this, a weight of the torque limiter apparatus becomes larger, and a total weight of the cap fastening apparatus in a state in which the torque limiter apparatus is attached to the chuck becomes larger. As a result, a moving apparatus which is used for moving the cap fastening apparatus from a cap delivery position to a cap fastening position or the like becomes larger in size.

Further, an outside dimension of the torque limiter apparatus becomes larger, and a total dimension becomes larger in size in a cap fastening facility which is provided with plural sets of the torque limiter apparatuses, the speed reducers and the chucks side by side, and can simultaneously fasten a plurality of caps to a plurality of bottles, respectively.

Further, a weight of the torque limiter apparatus becomes larger, a moment of inertia thereof becomes larger, a precision of a fastening torque of the cap which is limited by the torque limiter apparatus is lowered, and a value of the fastening torque applied to the cap becomes unstable.

(2) A cap driving apparatus which drives the cap to the bottle is not provided in the cap fastening apparatus. Even if it is intended to arrange the cap driving apparatus above a center axis of the chuck for providing the cap driving apparatus, the torque limiter apparatus is arranged on the center axis of the chuck. Accordingly, there is a risk that an impact blow which the cap driving apparatus applies to the torque limiter apparatus and the chuck directly acts on the torque limiter apparatus to damage it. The cap driving apparatus cannot be easily provided in the cap fastening apparatus.

An object of the present invention is to downsize a capacity of a torque limiter apparatus limiting a set torque which is necessary for fastening a cap by a chuck, in a cap fastening apparatus which threadably attaches the cap to a bottle by the chuck which is rotated by a motor.

Another object of the present invention is to easily provide a cap driving apparatus in the cap fastening apparatus.

### Means for Solving the Problem

In accordance with claim 1 of the present invention, there is provided a cap fastening apparatus in which a rotation of a motor is transmitted to a chuck while being decelerated by a speed reducer, and a cap gripped by the chuck is threadably attached to a bottle. A torque limiter apparatus is interposed between the motor and the speed reducer, the torque limiter apparatus disconnecting a transmission of a rotation from the motor to the chuck at a time when a rotational resistance of the chuck becomes larger than a set torque.

In accordance with claim 2 of the present invention, further in the invention in accordance with claim 1, wherein the torque limiter apparatus is arranged on a drive shaft of the speed reducer, and an axis of the chuck does not come into line with an axis of a drive shaft of the speed reducer.

In accordance with claim 3 of the present invention, further in the invention in accordance with claim 2, wherein the axis of the chuck is arranged on a driven shaft which is in parallel to the drive shaft of the speed reducer.

In accordance with claim 4 of the present invention, further in the invention in accordance with claim 1 or 2, wherein the driven shaft is provided in such a manner as to be movable in an axial direction with respect to the speed reducer.

In accordance with claim 5 of the present invention, further in the invention in accordance with 4, wherein a cap driving apparatus is provided above the driven shaft, and the cap is capable of being driven to the bottle on the basis of a movement in an axial direction of the driven shaft.

In accordance with claim 6 of the present invention, further in the invention in accordance with any one of claims 1 to 5, wherein a rotation of the motor is transmitted to a plurality of chucks via plural sets of the torque limiter apparatuses and the speed reducers.

In accordance with claim 7 of the present invention, further in the invention in accordance with any one of claims 1 to 6, wherein a reduction gear ratio of the speed reducer is set to be equal to or more than 1/2 and equal to or less than 1/10.

### Effects

In accordance with the present invention, in the cap fastening apparatus which threadably attaches the cap to the bottle by the chuck rotated by the motor, it is possible to downsize a capacity of the torque limiter apparatus limiting the set torque which is necessary for fastening the cap by the chuck.

Further, in accordance with the present invention, the cap driving apparatus can be easily provided in the cap fastening apparatus.

### BRIEF DESCRIPTION OF THE DRAWINGS

FIG. 1 is a front elevational view showing a basic structure of a cap fastening apparatus.

FIG. 2 is a perspective view of FIG. 1.

FIG. 3 is a perspective view showing a cap fastening facility to which a cap fastening apparatus is applied.

FIG. 4 is a perspective view showing a cap supplying and gripping state of the cap fastening facility.

FIG. 5 is a perspective view showing a cap gripping and forward moving state of the cap fastening facility.

FIG. 6 is a perspective view showing a cap grip threadably attaching state of the cap fastening facility.

FIG. 7 is a front elevational view showing a modified example of the cap fastening apparatus.

FIG. 8 is a perspective view of FIG. 7.

### BEST MODE FOR CARRYING OUT THE INVENTION

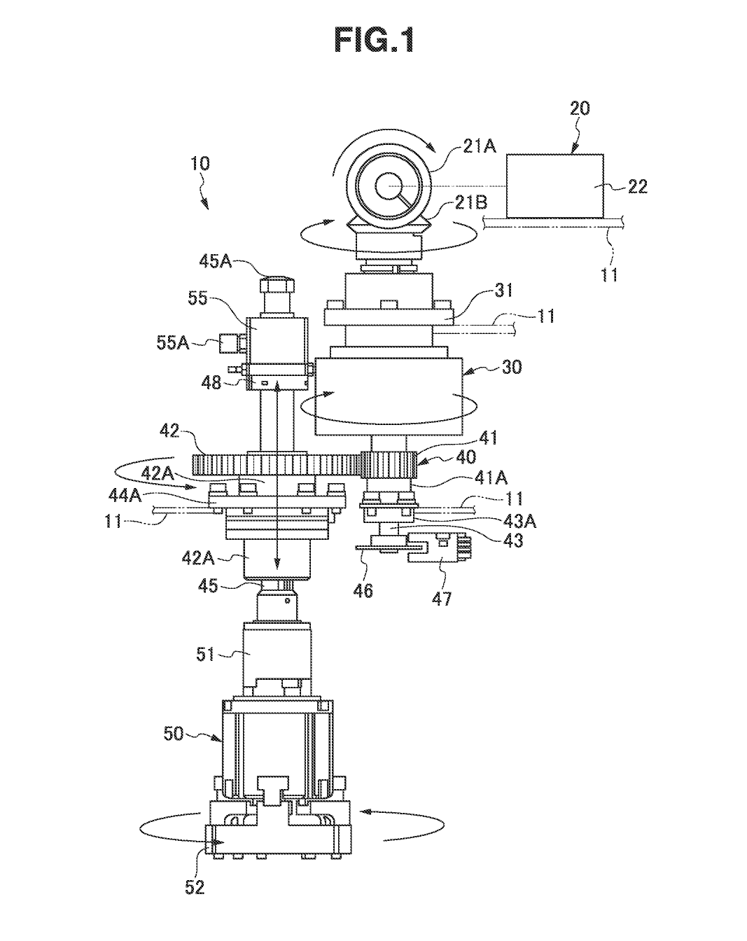

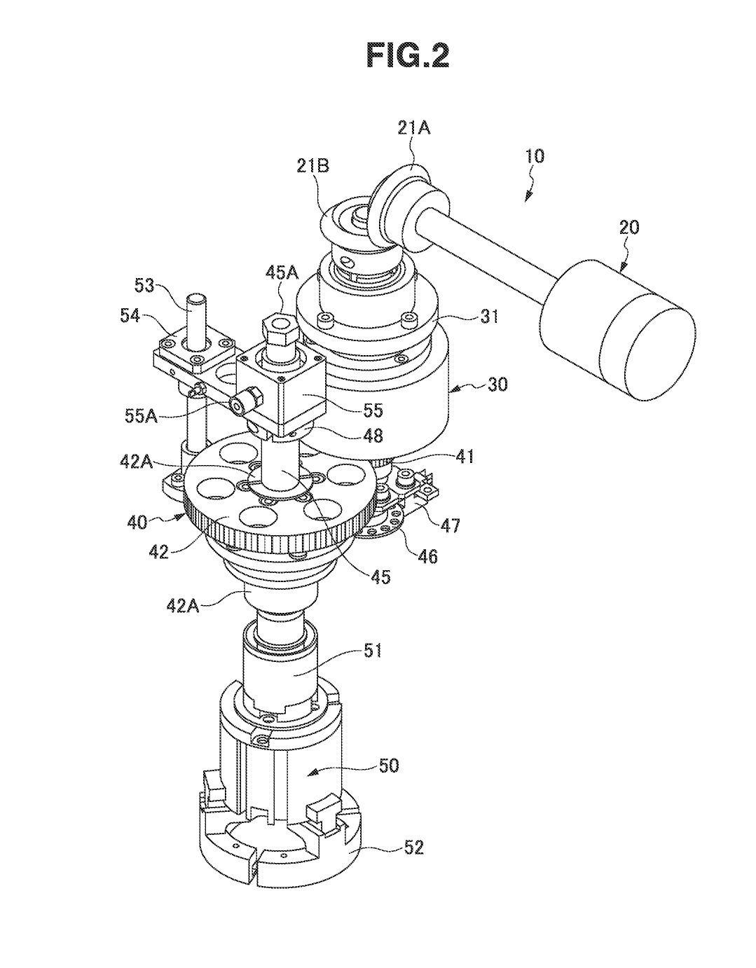

A cap fastening apparatus 10 is structured, as shown in FIG. 1 and FIG. 2, such that a rotation of a motor 20 is transmitted to a chuck 50 via a torque limiter apparatus 30 and a speed reducer 40, and a cap 1 can be threadably attached to a bottle 2 by a set torque. In this case, the cap fastening apparatus 10 can drive the cap 1 to the bottle 2.

In other words, the cap fastening apparatus 10 supports the motor 20, the torque limiter apparatus 30 and the speed reducer 40 in a supporting plate 11 which is supported to a stand (which is not illustrated in FIG. 1 and FIG. 2) so as to be movable in a back and forth direction and an up and down direction. In the cap fastening apparatus 10, a rotation of the motor 20 is decelerated by the speed reducer 40 so as to be transmitted to the chuck 50. On the basis of the transmitted rotation, the cap 1 which is gripped by the chuck 50 is threadably attached to the bottle 2. Further, when a rotational resistance of the chuck 50 becomes larger than a set torque, the torque limiter apparatus 30 which is interposed between the motor 20 and the speed reducer 40 and disconnects a transmission of the rotation from the motor 20 to the chuck 50 is actuated and the transmission is disconnected, whereby the cap 1 can be threadably attached to the bottle 2.

As the motor 20, there is employed a normal motor 20, for example, an inverter motor in which a speed can be set, however, there can be employed a motor in which a precise control can be carried out in a speed, an acceleration, a deceleration or the like of a servo motor, a stepping motor or the like. A vertical bevel gear 21A which is provided in a rotating shaft of the motor 20 is engaged with a transverse bevel gear 21B which is provided in an input shaft of the torque limiter apparatus 30, thereby transmitting the rotation of the motor 20 to the torque limiter apparatus 30 and changing the rotation in a horizontal direction of the rotating shaft of the motor 20 into a vertical direction which is in parallel to a center axis of the chuck 50. A case 22 of the motor 20 is fixed and supported to the supporting plate 11.

The torque limiter apparatus 30 is not particularly limited in its type. As one example, there can be employed a pneumatic type which can connect and disconnect the transmission of the set torque on the basis of a dynamic friction force between opposite friction discs. As another example, the torque limiter apparatus 30 can employ a magnet type which can connect and disconnect the transmission of the set torque on the basis of a magnetic force between opposite magnets. The pneumatic type torque limiter apparatus 30 is structured such that the opposite friction discs generate a friction powder, however, is inexpensive. The magnet type torque limiter apparatus 30 is structured such that the opposite magnets are not in contact with each other, and is semipermanently in maintenance free. A case 31 of the torque limiter apparatus 30 is fixed and supported to the supporting plate 11.

The speed reducer 40 can be constructed by an intermeshing gear train of a small gear 41 and a large gear 42. The rotation of the motor 20 is decelerated by a reduction gear ratio R (1/3 in the present embodiment) which is constructed by a gear ratio (1:3 in the present embodiment) of the small gear 41 and the larger gear 42, and is transmitted to the chuck 50. An aspect of the speed reducer 40 is not limited to a combination of spur gears such as the present embodiment, but can be optionally selected, for example, a speed reducer constructed by gears in accordance with the other aspect, a combination of a belt and a pulley and the like. The reduction gear ratio R is preferably set to be about equal to or more than 1/2 and equal to or less than 1/10. If a degree of the reduction gear ratio is too small (a value of a denominator is small and a value of a denominator is close to 1), it becomes hard to downsize the capacity of the torque limiter apparatus 30 which is an effect of the present invention. If the reduction gear ratio is too large (the value of the denominator is large), it is necessary to rotate the motor 20 at a high speed, and an expensive special motor is needed. A drive shaft 43 is fixed to a boss 41A of the small gear 41, an output shaft of the torque limiter apparatus 30 is connected to the drive shaft 43, and a bearing housing 43A pivotally supporting the drive shaft 43 is fixed and supported to the supporting plate 11. A bearing housing 44A pivotally supporting a boss 42A of the large gear 42 is fixed and supported to the supporting plate 11. A driven shaft 45 is constructed by a spline shaft, and the boss 42A is a spline shaft receiver. In particular, a ball spline is preferable since it has a high precision and a high rigidity. In other words, the boss 42A is provided with the driven shaft 45 which is connected in such a manner as to be integral in a rotating direction and be movable in an axial direction. It is preferable that an axis of the driven shaft 45 is deviated from an axis of the drive shaft 43 of the speed reducer 40 without coming into line with it, and they are in parallel to each other. In particular, it is preferable that the driven shaft 45 and the drive shaft 43 of the speed reducer 40 are arranged in parallel.

The chuck 50 is structured such that various chuck heads 52 which are used by being replaced in correspondence to a dimension and a shape of the cap 1 can be attached to and detached from a coupler 51 which is fixed to a lower end portion of the driven shaft 45 of the speed reducer 40. The chuck 50 supports a slide 54 to a vertical direction guide rod 53 which is fixed to the supporting plate 11 so as to be movable up and down, makes the driven shaft 45 pass through an inner periphery of a pneumatic manifold 55 which is provided in the slide 54 so as to be integrally and relatively rotatable in an axial direction, feeds a compressed air which is supplied from an air intake port 55A of the pneumatic manifold 55 to the chuck head 52 via a hollow portion of the driven shaft 45, and opens and closes the chuck head 52 on the basis of a pneumatic force so as to grip the cap 1. An axis of the chuck 50 comes into line with an axis of the driven shaft 45. In other words, it is preferable that the axis of the chuck 50 is deviated from the axis of the drive shaft 43 of the speed reducer 40 without coming into line with it, and they are in parallel to each other.

The driven shaft 45 is provided in such a manner as to be movable in an axial direction with respect to the large gear 42 which is supported to the supporting plate 11. In accordance with this, in a standby state of the cap fastening apparatus 10, the chuck 50 and the driven shaft 45 positions a positioning stopper 48 which is provided below the pneumatic manifold 55 locked to the driven shaft 45 in the axial direction, at a lowest position which comes into contact with an upper surface of the large gear 42, on the basis of a gravitational force acting on the chuck 50. The positioning stopper 48 is fixed to an appropriate position of the driven shaft 45. Further, an upper end portion of the driven shaft 45 protrudes to an upper portion of the pneumatic manifold 55 so as to form an impact blow portion 45A. A cap driving apparatus which is not illustrated is arranged above the impact blow portion 45A of the driven shaft 45. The cap driving apparatus is driven by an air cylinder, a motor-driven cylinder or the like, and the cap driving apparatus has a driving head which drives the impact blow portion 45A.

In accordance with the structure mentioned above, in the cap fastening apparatus 10, the torque limiter apparatus 30 is arranged on the axis of the drive shaft 43 of the speed reducer 40, and the chuck 50 is arranged on the axis of the driven shaft 45 which is in parallel to the drive shaft 43 of the speed reducer 40, whereby the screw cap 1 which is gripped to the chuck head 52 of the chuck 50 can be threadably attached to an opening portion of the bottle 2 by a fixed torque on the basis of the rotation of the motor 20. The supporting plate 11 comes down in such a manner as to attach the cap 1 gripped by the chuck head 52 of the chuck 50 to the above of the opening portion of the bottle 2, at a time of threadably attaching the cap 1 by the motor 20. As a result, the driven shaft 45 which is at the lowest position with respect to the large gear 42 of the speed reducer 40 moves up with respect to the large gear 42. Accordingly, a downward movement at a screw pitch of the cap 1 at a time when the chuck head 52 is subsequently rotated by the motor 20 so as to threadably attach the cap 1 to the opening portion of the bottle 2 is allowed within a range of a distance of the upward movement mentioned above with respect to the large gear 42 of the driven shaft 45. In this case, FIG. 1 and FIG. 2 show a state in which the driven gear 45 approximately moves up to an upper limit with respect to the large gear 42. An upper limit position at a time of moving upward is a position at which an upper portion of the coupler 51 which is larger than an outer diameter of the driven shaft 45 comes into contact with the boss 42A.

At this time, it is preferable that the motor 20 has a clutch type brake (the clutch type brake may be embedded in the motor 20, or may be attached to the rotating shaft of the motor 20). The rotation of the motor 20 can be immediately transmitted to the torque limiter apparatus 30, the speed reducer 40 and the chuck 50 sequentially by releasing the clutch type brake of the motor 20 at a time of starting the threadable attachment of the cap 1 by the motor 20. If the threadably attaching work of the cap 1 by the motor 20 is finished by an actuation of the torque limiter apparatus 30 at the limited torque, a change of a rotating condition, for example, a rotation deceleration or a rotation stop of a rotating dog 46 provided in the drive shaft 43 of the speed reducer 40 is read by a sensor 47 which is provided around the dog 46, and a control apparatus which is not illustrated disconnects in a moment the transmission of the rotation of the motor 20 by the clutch type brake of the motor 20, in accordance with the change of the rotating condition which is ready by the sensor 47, immediately releases the grip of the cap 1 by the chuck 50, and can finish the capping work by the cap fastening apparatus 10. On the basis of the structure mentioned above, it is possible to minimize the capping work time by the cap fastening apparatus 10 so as to improve a productivity. A control of a fastening torque of the cap 1 by the cap fastening apparatus 10 is carried out by the torque limiter apparatus 30, and the clutch of the motor 20 does not take part in the control of the fastening torque of the cap 1. Further, using a motor which can carry out a rapid acceleration and a rapid deceleration of the servo motor, the stepping motor or the like, in place of use of the motor 20 having the clutch type brake, it is possible to immediately transmit the rotation of the motor 20 to the torque limiter apparatus 30, the speed reducer 40 and the chuck 50 sequentially, at a time of starting the threadable attachment as mentioned above. At a time of finishing the threadable attachment, it is possible to stop the rotation of the motor 20 in a moment, to immediately release the grip of the cap 1 by the chuck 50, and to finish the capping work by the cap fastening apparatus 10.

Accordingly, in the present invention, the term “clutch” indicates a structure which disconnects a rotating motion from an input shaft to an output shaft and a torque transmission on the basis of a control signal or any operation from an external portion. In this case, a means for preventing a torque beyond a set value of the input shaft from being transmitted to the output shaft is constructed by the torque limiter apparatus.

Further, in the cap fastening apparatus 10, the driven shaft 45 is provided in such a manner as to be movable in the axial direction with respect to the large gear 42 of the speed reducer 40, and the drive cap 1 can be driven to the opening portion of the bottle 2 by a drive head (not illustrated) which is provided in a lower end portion of the driven shaft 45, on the basis of a movement in the axial direction of the driven shaft 45. At a time of driving the cap 1, the drive head which is provided in the lower end portion of the driven shaft 45 of the speed reducer 40 locates at a position which corresponds to an appropriate driving operation position with respect to the opening portion of the bottle 2, on the basis of the rotation of the driven shaft 45, and the drive head and the cap 1 are mounted on the opening portion of the bottle 2, on the basis of a downward movement of the supporting plate 11. As a result, the driven shaft 45 existing at the lowest position with respect to the large gear 42 of the speed reducer 40 moves up with respect to the large gear 42. Accordingly, the downward movement of the cap 1 at a time when the cap driving apparatus which is not illustrated subsequently drives the impact blow portion 45A in the upper end portion of the driven shaft 45 so as to drive the cap 1 to the opening portion of the bottle 2 is allowed within the range of the amount of the upward movement mentioned above with respect to the large gear 42 of the driven shaft 45.

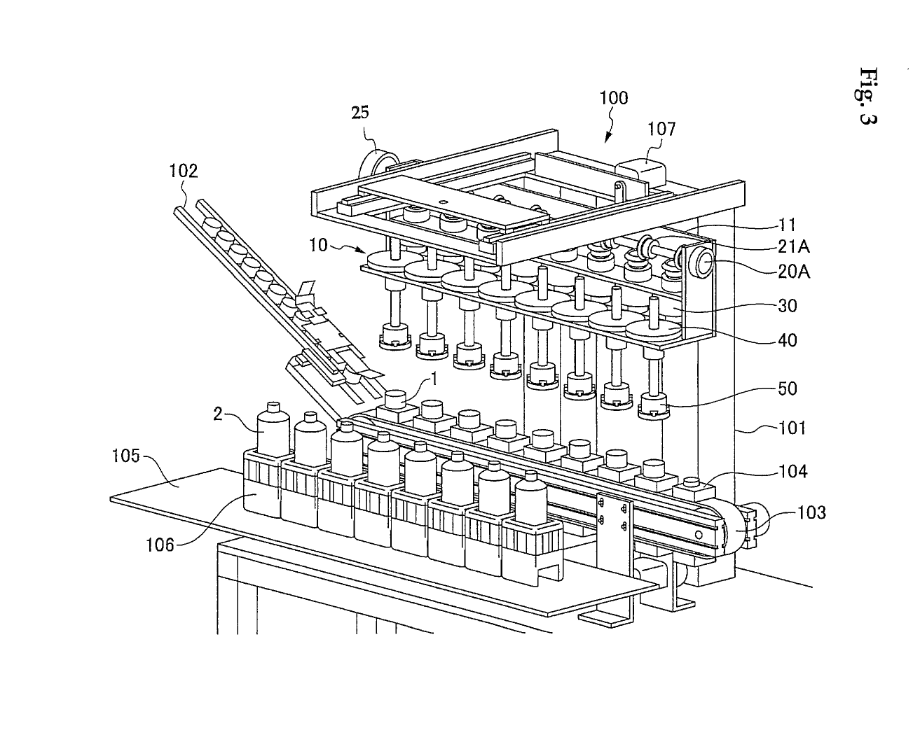

A description will be given of a cap fastening facility 100 which employs the cap fastening device 10. The cap fastening facility 100 is structured, as shown in FIG. 3, such that a stand 101 is provided with a cap supplying chute 102, the cap supplying chute 102 is provided with a subsequent cap separating and supplying conveyor 103, and the cap 1 which is supplied from the cap supplying chute 102 can be transferred to a plurality of cap separating and supplying plates 104 which are arranged in a cap separating and supplying zone formed as one row on the cap separating and supplying conveyor 103.

Further, the cap fastening facility 100 is provided with a container feeding conveyor 105 in a front surface of the cap separating and supplying conveyor 103, and can feed while accommodating the bottle 2 in each of the plurality of container feeding skirts 106 which are formed as one row on the container feeding conveyor 105 and are arranged in a cap fastening zone. The cap separating and supplying plates 104 are arranged in the cap separating and supplying zone on the cap separating and supplying conveyor 103, the skirts 106 are arranged in the cap fastening zone on the container feeding conveyor 105, and each of the cap separating and supplying plates 104 and each of the skirts 106 correspond to each other in one-to-one relationship.

The cap fastening facility 100 is provided in the stand 101 with the supporting plate 11 which can move in a back and forth direction by a servo motor 107 for a forward and backward movement and can move in an up and down direction by a servo motor for an upward and downward movement (not illustrated). The cap fastening facility 100 is structured such that each of the cap fastening apparatuses 10 mentioned above is installed at each of positions on the supporting plate 11 respectively corresponding to the plurality of cap separating and supplying plates 104 which are arranged in one row on the cap separating and supplying conveyor 103 and stay in the cap separating and supplying zone, and the plurality of skirts 106 which are arranged in one row on the container feeding conveyor 105 and stay in the cap fastening zone. The cap fastening facility 100 is provided in one side of the supporting plate 11 with a timing pulley 20 which is driven via a timing belt by one motor (not illustrated), and a long rotating shaft 20A which is driven by the timing pulley 20 driven by the motor (not illustrated) extends along the cap separating and supplying conveyor 103 of the supporting plate 11 and the container feeding conveyor 105. Further, the vertical bevel gear 21A of the cap fastening apparatus 10 is provided at each of the positions in the axial direction of the rotating shaft 20A, and the transverse bevel gear 21B engaging with the vertical bevel gear 21A, the torque limiter apparatus 30, the speed reducer 40 and the chuck 50 are provided in the same as shown in FIG. 1 and FIG. 2.

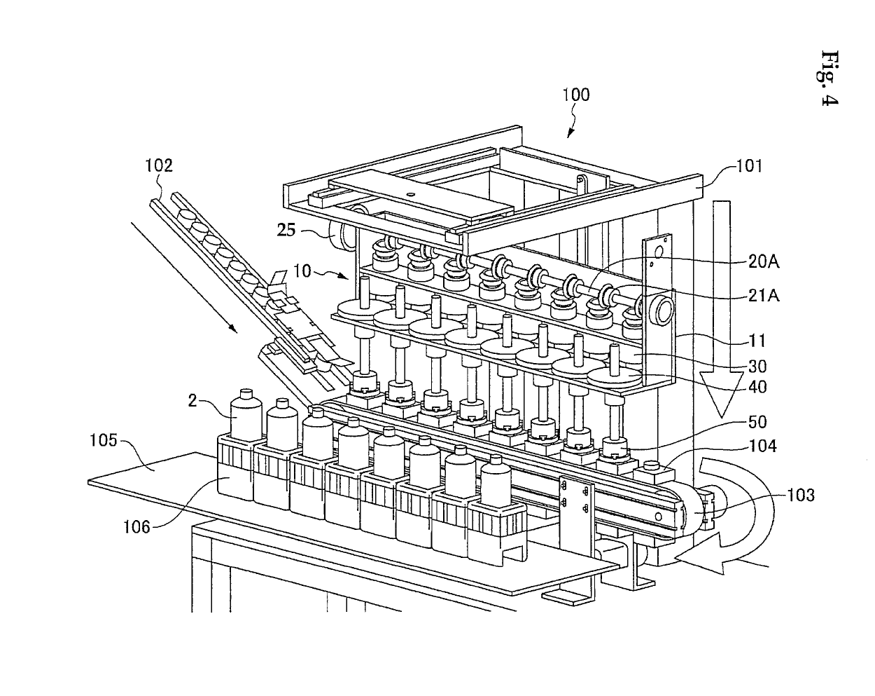

Accordingly, a cap fastening motion by the cap fastening facility 100 is carried out as shown below (FIG. 4 to FIG. 6).

(A) Cap supplying and gripping step (FIG. 4)

(1) The cap 1 is supplied to the cap supplying chute 102.

(2) The cap separating and supplying conveyor 103 rotates, and the cap 1 of the cap supplying chute 102 is supplied to the cap separating and supplying plate 104 of the cap separating and supplying conveyor 103.

(3) When the cap 1 is supplied to all the cap separating and supplying plates 104 in the cap separating and supplying zone which form one row on the cap separating and supplying conveyor 103, the supporting plate 11 comes down by the servo motor for the upward and downward movement, and the cap 1 in each of the cap separating and supplying plates 104 is gripped by the chuck head 52 of the chuck 50 in each of the cap fastening apparatuses 10.

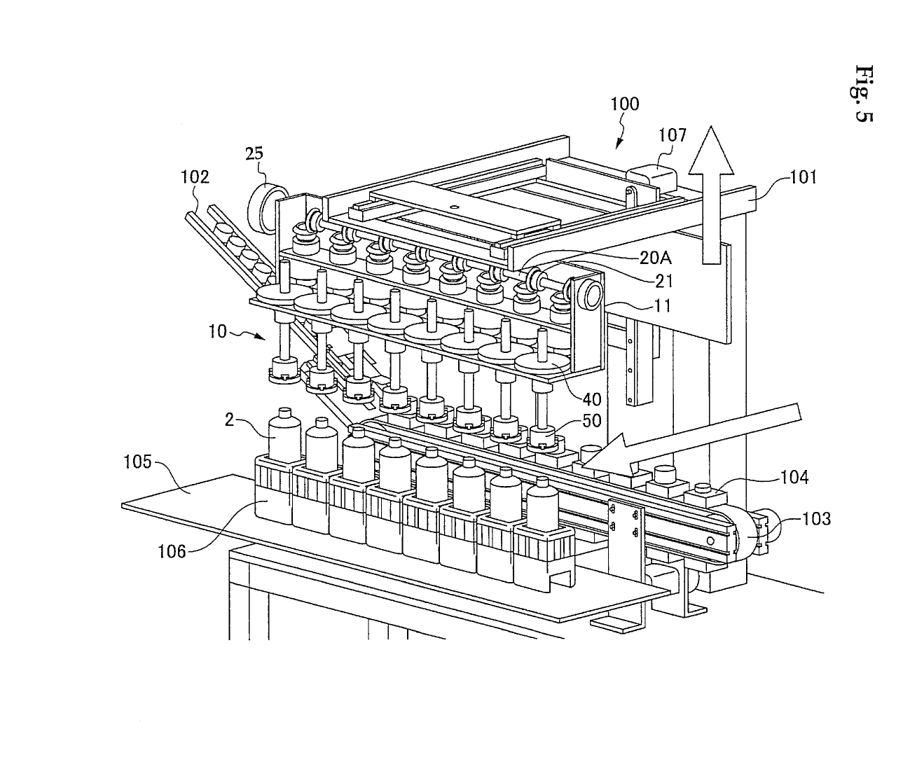

(B) Cap gripping and forward moving step (FIG. 5)

(1) The supporting plate 11 is moved up by the servo motor for the upward and downward movement.

(2) The supporting plate 11 is moved forward by the servo motor 107 for the forward and backward movement, and the cap 1 which the chuck head 52 of the chuck 50 in each of the cap fastening apparatuses 10 grips is positioned in the upper portion of the bottle 2 which is accommodated in each of the skirts 106 on the container feeding conveyor 105.

(3) The cap separating and supplying conveyor 103 rotates, and supplies the cap 1 in the cap supplying chute 102 to the cap separating and supplying plate 104 of the cap separating and supplying conveyor 103.

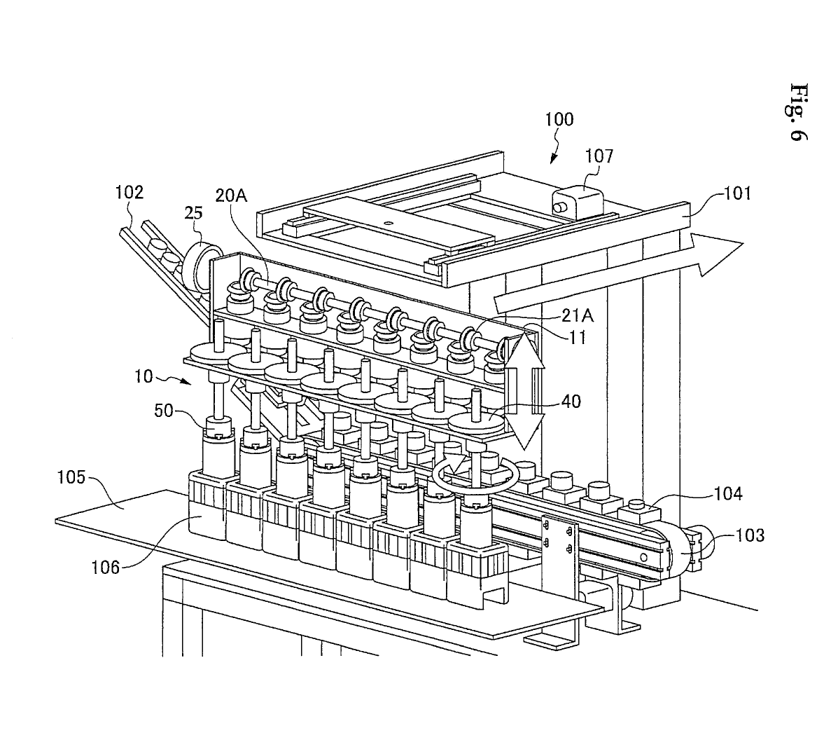

(C) Cap gripping and fastening step (FIG. 6)

(1) The supporting plate 11 is moved down by the servo motor for the upward and downward movement, and the cap 1 which the chuck head 52 of the chuck 50 in each of the cap fastening apparatuses 10 grips is pressed against the opening portion of the bottle 2 which is accommodated in each of the skirts 106 on the container feeding conveyor 105.

(2) The chuck head 52 of the chuck 50 is rotated by the timing pulley 20 which is driven by the motor (not illustrated) of each of the cap fastening apparatuses 10, and the cap 1 is threadably attached to the opening portion of the bottle 2 by the set torque which is determined by the torque limiter apparatus 30. The end of the threadable attachment of the cap 1 is detected by the sensor 47 mentioned above, the transmission of the rotation of the motor 20 is disconnected in a moment by the clutch type brake of the motor 20, and the grip of the cap 1 by the chuck 50 is immediately released.

On the other hand, a drive cap 1 uses the drive head of the cap driving apparatus which is provided in the driven shaft 45 of the speed reducer 40 in each of the cap fastening apparatuses 10. The drive head drives the impact blow portion 45A of the driven shaft 45, and carries out the driving on the basis of the movement in the axial direction of the driven shaft 45.

(3) The supporting plate 11 is moved up by the servo motor for the upward and downward movement, the supporting plate 11 is subsequently moved backward by the servo motor 107 for the forward and backward movement, and each of the cap fastening apparatuses 10 is returned to the standby position on the cap separating and supplying conveyor 103.

In accordance with the cap fastening apparatus 10 of the present embodiment, the following operations and effects can be achieved.

(a) The torque limiter apparatus 30 is interposed between the motor 20 and the speed reducer 40, the torque limiter apparatus 30 disconnecting the transmission of the rotation from the motor 20 to the chuck 50, at a time when the rotational resistance of the chuck 50 becomes larger than the set torque. The fastening torque of the cap 1 by the chuck 50 is limited by the torque limiter apparatus 30 via the speed reducer 40. On the assumption that the reduction gear ratio of the speed reducer 40 is set to R (for example, 1/3), the limited torque by the torque limiter apparatus 30 is reduced to R times the set torque mentioned above. Accordingly, it is possible to downsize the capacity of the torque limiter apparatus 30 in comparison with the magnitude of the set torque of the cap fastening apparatus 10, that is, the capacity in the case that the torque limiter apparatus 30 exists between the speed reducer and the chuck such as the prior art. In the case that the reduction gear ratio R is 1/3 as one example, it is possible to set the capacity of the torque limiter apparatus 30 to 1/3.

In accordance with this, the weight of the torque limiter apparatus 30 becomes small, and the whole weight of the cap fastening apparatus 10 in which the torque limiter apparatus 30 is accessorily provided in the chuck 50 becomes small. As a result, the moving apparatus (the servo motor 107 for the forward and backward movement and the servo motor for the upward and downward movement) which moves the cap fastening apparatus 10 from the cap delivery position to the cap fastening position is downsized.

Further, the outside dimension of the torque limiter apparatus 30 becomes smaller, and a total dimension of the cap fastening facility 100 is downsized, the cap fastening facility 100 being installed in parallel with the plural sets, each set being constructed by the torque limiter apparatus 30, the speed reducer 40 and the chuck 50, and being capable of fastening a plurality of caps 1 to a plurality of bottles 2.

Further, the weight of the torque limiter apparatus 30 becomes smaller, the moment of inertia thereof becomes smaller, the precision of the fastening torque of the cap 1 which is limited by the torque limiter apparatus 30 is improved, and the value of the fastening torque which is applied to the cap 1 is stabilized.

(b) The cap driving apparatus driving the cap 1 to the bottle 2 can be additionally provided in the cap fastening apparatus 10. The torque limiter apparatus 30 which is arranged on the drive shaft 43 of the speed reducer 40, and the chuck 50 which is arranged on the driven shaft 45 of the speed reducer 40 are arranged in parallel without bringing the axes into line with each other, that is, in the state in which the axes are deviated, and the torque limiter apparatus 30 is not arranged on the center axis of the chuck 50. Accordingly, even if the cap driving apparatus is arranged above the center axis of the chuck 50, the impact blow which the cap driving apparatus applies to the chuck 50 does not directly act on the torque limiter apparatus 30 to damage it. The cap driving apparatus can be easily provided additionally in the cap fastening apparatus 10.

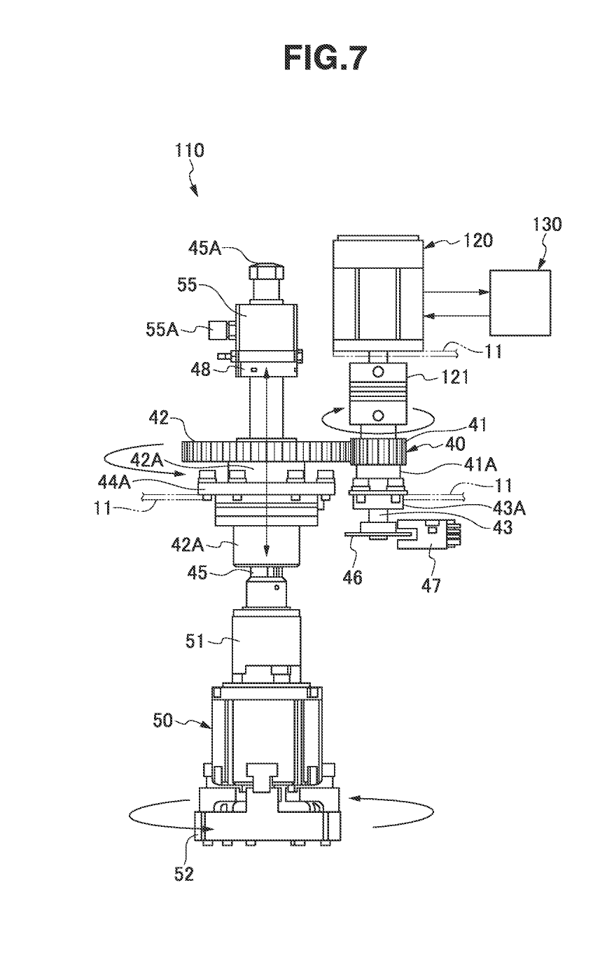

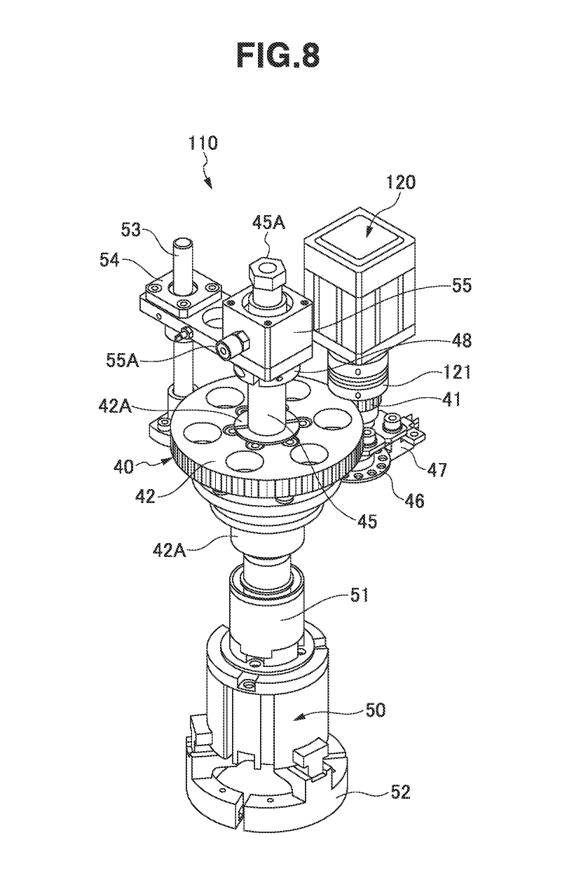

A cap fastening apparatus 110 shown in FIG. 7 and FIG. 8 is constructed by a servo motor 120, a torque limiter apparatus 130 (FIG. 7), the speed reducer 40 and the chuck 50. A different point of the cap fastening apparatus 110 from the cap fastening apparatus 10 mentioned above exists in a point that the set of the motor 20 and the torque limiter apparatus 30 mentioned above is replaced with the servo motor 120 (the torque limiter apparatus 130). An output shaft of the servo motor 120 is connected to the drive shaft 43 of the speed reducer 40 via a coupling 121. In other words, a servo amplifier additionally provided in the servo motor 120 is used as the torque limiter apparatus 130, a current value which the servo motor 120 rotating the chuck 50 consumes, that is, a magnitude of the torque is output from the servo amplifier, and in the case that an instantaneous torque data of the servo motor 120 obtained thereby becomes larger than the set torque of the chuck 50, or is expected to become larger, the servo motor 120 is stopped, and the transmission of the rotation from the servo motor 120 to the chuck 50 is disconnected.

In accordance with the cap fastening apparatus 110, the torque limiter apparatus 130 constructed by the servo motor 120 is interposed between the servo motor 120 and the speed reducer 40, and it is possible to set the servo motor 120 (the torque limiter apparatus 130) to the low torque type and employ the servo motor 120 which is compact and light in weight, in the same manner as the torque limiter apparatus 30 of the cap fastening apparatus 10. Further, the motor type is not limited to the servo motor, but can employ in the same manner a motor in which a magnitude of a torque can be output.

In this case, a pair of vertical and transverse bevel gear trains can be interposed in a connection portion between the output shaft of the servo motor 120 and the drive shaft 43 of the speed reducer 40, and the output shaft of the servo motor 120 can be arranged in a horizontal direction which is orthogonal to the center axis of the chuck 50.

### INDUSTRIAL APPLICABILITY

In accordance with the present invention, in the cap fastening apparatus in which the cap is threadably attached to the bottle by the chuck rotated by the motor, it is possible to downsize the capacity of the torque limiter apparatus limiting the set torque which is necessary for fastening the cap by the chuck. Further, in accordance with the present invention, the cap driving apparatus can be easily provided additionally in the cap fastening apparatus.

### EXPLANATIONS OF LETTERS OR NUMERALS

1 cap
2 bottle
10 cap fastening apparatus
20 motor
30 torque limiter apparatus
40 speed reducer
43 drive shaft
45 driven shaft
50 chuck
100 cap fastening facility
110 cap fastening apparatus
120 servo motor
130 torque limiter apparatus

1. A cap fastening apparatus in which a rotation of a motor is transmitted to a chuck while being decelerated by a speed reducer, and a cap gripped by the chuck is threadably attached to a bottle,
wherein a torque limiter apparatus is interposed between the motor and the speed reducer, the torque limiter apparatus disconnecting a transmission of a rotation from the motor to the chuck at a time when a rotational resistance of the chuck becomes larger than a set torque.

2. The cap fastening apparatus according to claim 1, wherein the torque limiter apparatus is arranged on a drive shaft of the speed reducer, and an axis of the chuck does not come into line with an axis of a drive shaft of the speed reducer.

3. The cap fastening apparatus according to claim 2, wherein the axis of the chuck is arranged on a driven shaft which is in parallel to the drive shaft of the speed reducer.

4. The cap fastening apparatus according to claim 2, wherein the driven shaft is provided in such a manner as to be movable in an axial direction with respect to the speed reducer.

5. The cap fastening apparatus according to claim 4, wherein a cap driving apparatus is provided above the driven shaft, and the cap is capable of being driven into the bottle on the basis of a movement in an axial direction of the driven shaft.

6. The cap fastening apparatus according to claim 1, wherein a rotation of the single motor is transmitted to a plurality of chucks via plural sets of the torque limiter apparatuses and the speed reducers.

7. The cap fastening apparatus according to claim 1, wherein a reduction gear ratio of the speed reducer is set to be 1/2 to 1/10.

8. The cap fastening apparatus according to claim 2, wherein a rotation of the single motor is transmitted to a plurality of chucks via plural sets of the torque limiter apparatuses and the speed reducers.

9. The cap fastening apparatus according to claim 3, wherein a rotation of the single motor is transmitted to a plurality of chucks via plural sets of the torque limiter apparatuses and the speed reducers.

10. The cap fastening apparatus according to claim 4, wherein a rotation of the single motor is transmitted to a plurality of chucks via plural sets of the torque limiter apparatuses and the speed reducers.

11. The cap fastening apparatus according to claim 5, wherein a rotation of the single motor is transmitted to a plurality of chucks via plural sets of the torque limiter apparatuses and the speed reducers.
